(19) United States
(12) Patent Application Publication
(10) Pub. No.: US 2024/0033845 A1
(43) Pub. Date: Feb. 1, 2024

(54) METHOD OF OPERATING AN IRRADIATION SYSTEM, IRRADIATION SYSTEM AND APPARATUS FOR PRODUCING A THREE-DIMENSIONAL WORK PIECE

(71) Applicant: SLM SOLUTIONS GROUP AG, Luebeck (DE)

(72) Inventors: Daniel Brueck, Luebeck (DE); Knut Krause, Luebeck (DE); André Schoebel, Luebeck (DE)

(21) Appl. No.: 18/021,271

(22) PCT Filed: Oct. 6, 2021
(86) PCT No.: PCT/EP2021/077495

§ 371 Date: Feb. 14, 2023

(30) Foreign Application Priority Data
Oct. 6, 2020 (DE) 10 2020 126 074.1

(51) Int. Cl. B23K 15/00; B22F 12/40; B22F 10/36; B33Y 10/00; B33Y 50/02; B33Y 30/00

(52) U.S. Cl. CPC B23K 15/0086; B22F 12/40; B22F 10/36; B33Y 10/00; B33Y 50/02; B33Y 30/00; B22F 10/28

(57) ABSTRACT

In a method of operating an irradiation system (10) for irradiating layers of a raw material powder with electromagnetic or particle radiation in order to produce a three-dimensional work piece (110) it is determined whether a region of a raw material powder layer (11) to be selectively irradiated with electromagnetic or particle radiation in accordance with a geometry of a corresponding layer of the work piece (110) to be produced is affected or substantially unaffected by particulate impurities. Upon selectively irradiating the region of the raw material powder layer (11) with electromagnetic or particle radiation, an energy density applied to the region of the raw material powder layer (11) by a radiation beam (14a, 14b) is controlled in such a manner that the energy density is higher in case it is determined that the region of the raw material powder layer (11) is affected by particulate impurities than in case it is determined that the region of the raw material powder layer (11) is substantially unaffected by particulate impurities.

The invention is directed to a method of operating an irradiation system for irradiating layers of a raw material powder with electromagnetic or particle radiation in order to produce a three-dimensional work piece. Further, the invention is directed to an irradiation system of this kind. Finally, the invention is directed to an apparatus for producing a three-dimensional work piece.

Powder bed fusion is an additive layering process by which pulverulent, in particular metallic and/or ceramic raw materials can be processed to three-dimensional work pieces of complex shapes. To that end, a raw material powder layer is applied onto a carrier and subjected to laser radiation in a site selective manner in dependence on the desired geometry of the work piece that is to be produced. The laser radiation penetrating into the powder layer causes heating and consequently melting or sintering of the raw material powder particles. Further raw material powder layers are then applied successively to the layer on the carrier that has already been subjected to laser treatment, until the work piece has the desired shape and size. Powder bed fusion may be employed for the production or repairing of prototypes, tools, replacement parts, high value components or medical prostheses, such as, for example, dental or orthopaedic prostheses, on the basis of CAD data.

An exemplary apparatus for producing three-dimensional work pieces by powder bed fusion as described in EP 3 321 003 B1 comprises a process chamber accommodating a carrier for receiving a raw material powder. An irradiation device is provided to selectively irradiate electromagnetic or particle radiation onto the raw material powder on the carrier in order to produce a work piece. A protective gas stream is directed through the process chamber for establishing a desired atmosphere within the process chamber and for discharging impurities from the process chamber.

Upon building up a three-dimensional work piece on the carrier of a powder bed fusion apparatus, the radiation energy introduced into the raw material powder causes the raw material powder to melt and/or sinter. Specifically, a melt pool of molten raw material is generated in a region where the radiation beam impinges on the raw material powder. In the course of the melting of the raw material powder, welding smoke is generated which typically forms a smoke plume containing lightweight particulate impurities, such as smoke particles, dispersed raw material powder particles and soot particles. Although the major part of the light welding smoke particles is discharged from the process chamber by being entrained with the gas stream guided through the process chamber, the smoke plume of lightweight particulate impurities may still undesirably shield and/or scatter a radiation beam which, before impinging onto the raw material powder to be irradiated, is directed through the smoke plume.

In addition, the evaporation of raw material from the melt pool may cause splash particles to spray from the melt pool. Splash particles that spray from the melt pool in molten form and thereafter solidify, however, typically are too heavy to be entrained with the gas stream guided through the process chamber and hence are deposited either on the surface of non-irradiated raw material powder of a just selectively irradiated raw material powder layer or on the surface of a just generated work piece layer. Therefore, these solidified splash particles may cause defects and/or irregularities in the work piece to be produced.

It is an object of the present invention to provide a method of operating an irradiation system for irradiating layers of a raw material powder with electromagnetic or particle radiation in order to produce a three-dimensional work piece and an irradiation system of this kind which allow the production of high-quality work pieces. Further, the invention is directed to an apparatus for producing a three-dimensional work piece which allows the production of high-quality work pieces.

In a method of operating an irradiation system for irradiating layers of a raw material powder with electromagnetic or particle radiation in order to produce a three-dimensional work piece, a raw material powder layer to be selectively irradiated with electromagnetic or particle radiation in accordance with a geometry of a corresponding layer of the work piece to be produced is subdivided into a plurality of regions. For example, the raw material powder layer may be subdivided into a plurality of stripes. The stripes may extend substantially parallel to each other. Further, the stripes may extend substantially perpendicular to a direction of flow of a gas stream directed across the raw material powder layer in order to remove particulate impurities. Additionally or alternatively, it is also conceivable to subdivide the raw material powder layer into a plurality of stripes which may extend substantially parallel to the direction of flow of the gas stream directed across the raw material powder layer. The raw material powder layer regions may remain fixed for all raw material powder layers to be irradiated upon producing a work piece or may vary in dependence on the size, the shape and/or the position of a work piece layer to be produced by selectively irradiating a respective one of the raw material powder layers.

For at least one region, it is determined prior to selectively irradiating said region with electromagnetic or particle radiation, whether said region is affected or substantially unaffected by particulate impurities. The term “affected by particulate impurities” in the context of this application should be understood so as to indicate a state of the raw material powder layer region which may impair the quality of a work piece layer portion produced by selectively irradiating the raw material powder layer region. Accordingly, the term “substantially unaffected by particulate impurities” in the context of this application should be understood so as to indicate a state of the raw material powder layer region which allows the production of a work piece layer portion by selectively irradiating the raw material powder layer region which is substantially free from defects and irregularities caused by particulate impurities.

The irradiation system for selectively irradiating electromagnetic or particle radiation onto the raw material powder layer may comprise a radiation beam source, in particular a laser beam source, and additionally may comprise at least one optical unit for splitting, guiding and/or processing at least one radiation beam emitted by the radiation beam source. The optical unit may comprise optical elements such as an object lens and a scanner unit, the scanner unit preferably comprising a diffractive optical element and a deflection mirror. The irradiation system may irradiate the raw material powder layer with a single radiation beam. It is, however, also conceivable that the irradiation system irradiates two or more radiation beams onto the raw material powder layer.

The raw material powder layer may be applied onto a surface of a carrier by means of a powder application device which is moved across the carrier so as to distribute the raw material powder. The carrier may be a rigidly fixed carrier. Preferably, however, the carrier is designed to be displaceable in vertical direction, so that, with increasing construction height of the work piece, as it is built up in layers from the raw material powder, the carrier can be moved downwards in the vertical direction. Further, the carrier may be provided with a cooling device and/or a heating device which are configured to cool and/or heat the carrier. The carrier and the powder application device may be accommodated within a process chamber which is sealable against the ambient atmosphere. An inert gas atmosphere may be established within the process chamber by introducing a gas stream into the process chamber via a gas inlet. After being directed through the process chamber and across a raw material powder layer applied onto the carrier, the gas stream may be discharged from the process chamber via a gas outlet. The raw material powder applied onto the carrier within the process chamber is preferably a metallic powder, in particular a metal alloy powder, but may also be a ceramic powder or a powder containing different materials. The powder may have any suitable particle size or particle size distribution. It is, however, preferable to process powders of particle sizes <100 μm.

The particulate impurities that may affect the raw material powder layer region in the recent or following layer may be particles, for example solidified splash particles, that are too heavy and/or too large to be removed from the process chamber by being entrained with a gas stream guided through the process chamber and therefore are deposited either on the surface of (still) non-irradiated raw material powder of a just selectively irradiated raw material powder layer or on the surface of a work piece layer just generated by selectively irradiating said raw material powder layer. If the particulate impurities that are generated upon irradiating a raw material powder layer are deposited in a portion of the raw material powder layer that is still to be irradiated, these particulate impurities may already affect the quality of the work piece layer portion generated by selectively irradiating said raw material powder layer portion. The quality of the work piece layer portion generated by selectively irradiating said raw material powder layer portion may, however, also be affected by particulate impurities which are generated upon irradiating a previous raw material powder layer and which are covered with and/or incorporated into the raw material powder of said raw material powder layer portion.

Alternatively or additionally thereto, the particulate impurities that are expected to affect the region of the raw material powder layer may be lighter particles such as, for example, welding smoke particles, dispersed raw material powder particles and soot particles which typically form a smoke plume originating from a melt pool of molten raw material powder which is generated in a region where the radiation beam impinges on the raw material powder. The smoke plume of lightweight particulate impurities may shield and/or scatter a radiation beam which, before impinging onto the raw material powder layer to be irradiated, is guided through the smoke plume. This may also affect the quality of a work piece layer portion generated by selectively irradiating the region of the raw material powder layer.

Upon selectively irradiating the at least one region of the raw material powder layer with electromagnetic or particle radiation, for which the determination has been made, whether the region is affected or substantially unaffected by particulate impurities, an energy density applied to the region of the raw material powder layer by a radiation beam is controlled. In more detail, the energy density is controlled in such a manner that the energy density is higher in case it is determined that the region of the raw material powder layer is affected by particulate impurities than in case it is determined that the region of the raw material powder layer is substantially unaffected by particulate impurities.

Due to the increased energy density applied to the raw material powder layer region in case it is affected by particulate impurities, not only the raw material powder particles, but also solidified splash particles that are deposited on a surface of the raw material powder layer or embedded in the raw material powder layer melt when the radiation beam is guided across the region of the raw material powder layer. In addition, a shielding and/or scattering effect caused by a smoke plume of lightweight particulate impurities, e.g. caused from a melt pool of another laser beam or the obstructed beam itself, can be compensated for. Consequently, irregularities or defects in the work piece layer which result from an incomplete melting of raw material powder particles and/or particulate impurities can be minimized or even avoided.

Simultaneously, by applying a lower energy density to the raw material powder layer region in case it is unaffected by particulate impurities, undesired effects of an excess energy application such as, for example, the formation of an undesirably large melt pool and increased splashing of molten raw material from the melt pool caused by excessive evaporation are avoided. Finally, the raw material powder layer region is qualified as being either affected or substantially unaffected by particulate impurities before the irradiation of the region is started, the energy density applied to the region can be tailored in a particularly reliable and accurate manner. In summary, the overall quality of the work piece layer generated by selectively irradiating the raw material powder layer can be improved.

The energy density applied to the region of the raw material powder layer may be controlled by suitably adapting at least one of a power, a focus diameter and a focus shape of a radiation beam directed across the raw material powder layer. Specifically, the energy density applied to the raw material powder layer region may be increased by increasing the power of the radiation beam, by decreasing the focus diameter of the radiation beam and/or by changing the focus shape of the radiation beam in such a manner that a focus area of the radiation beam is reduced. The expression “focus shape of the radiation beam” in the sense of the application, may be understood not only as the outer shape or contour of the radiation beam spot incident on the raw material powder, such as round, ring-shaped or rectangular, but also as an internal intensity profile in the focus, like a gauss-, top-hat- or donut-distribution.

Alternatively or additionally thereto, the energy density applied to the region of the raw material powder layer may be controlled by suitably adapting at least one of a scan speed and a scan pattern according to which the radiation beam is directed across the raw material powder layer. In particular, the energy density applied to the raw material powder layer region may be increased by decreasing the scan speed and/or by modifying the scan pattern in such a manner that a distance between adjacent scan vectors defining the scan pattern is reduced.

The determination of whether a region of the raw material powder layer is affected or substantially unaffected by particulate impurities may be made in dependence on a direction of flow of a gas stream which is directed across the raw material powder layer, i.e. in dependence on a direction of flow of the gas stream which is directed through the process chamber in order to establish a desired atmosphere within the process chamber and in order remove particulate impurities from the process chamber.

Further process parameters, that may affect the spatter and/or plume generation, e.g. material of the raw material powder, used shielding gas, angle of incidence of the irradiation beam, etc. may be considered for the determination. The determination of whether a region of the raw material powder layer is affected or substantially unaffected by particulate impurities may therefore also be made in dependence on a spatter trajectory determined based on a flow speed of a gas stream directed across the raw material powder layer, a gas flow profile of a gas stream directed across the raw material powder layer and/or a particle weight of the particulate impurities.

For example, a raw material powder layer region which, with respect to the direction of flow of the gas stream directed across the raw material powder layer, is arranged in a downstream region of the raw material powder layer, i.e. distant from the gas inlet of the process chamber and in the vicinity of the gas outlet of the process chamber, typically is affected by both splash particles and a smoke plume of lightweight particulate impurities which are emitted from the melt pool when a radiation beam irradiates a raw material powder layer region which, with respect to the direction of flow of the gas stream directed across the raw material powder layer, is arranged in an upstream region of the raw material powder layer, i.e. in the vicinity of the gas inlet of the process chamber and distant from the gas outlet of the process chamber. Consequently, the raw material powder layer region arranged in a downstream region of the raw material powder layer may be determined as being affected by particulate impurities and, upon being selectively irradiated, subjected to an increased energy density.

A region of the raw material powder layer which extends for a predetermined distance from an upstream edge of the raw material powder layer in the direction of flow of the gas stream directed across the raw material powder layer may be considered as a region of the raw material powder layer which is substantially unaffected by particulate impurities. The term “upstream edge” in the context of this application designates an edge of the raw material powder layer which faces the gas inlet via which the gas stream to be directed across the raw material powder layer is introduced into the process chamber.

Alternatively or additionally thereto, a region of the raw material powder layer which extends for a predetermined distance from an upstream irradiation starting position in the direction of flow of the gas stream directed across the raw material powder layer may be considered as a region of the raw material powder layer which is substantially unaffected by particulate impurities. The term “upstream irradiation starting position” in the context of this application designates an irradiation position, i.e. a location at which the radiation beam impinges on the raw material powder layer, which is located furthest in the direction of a gas inlet via which the gas stream directed across the raw material powder layer is introduced into the process chamber. The predetermined distance may be determined based on an estimation of the “purifying effect” of the gas stream directed through the process chamber and preferably is selected in such a manner that it is ensured that the raw material powder layer region remains substantially unaffected by particulate impurities.

The raw material powder layer to be selectively irradiated with electromagnetic or particle radiation may be subdivided into a plurality of regions prior to starting the production of the three-dimensional work piece. For example, the raw material powder layer may be subdivided into a plurality of stripes, a plurality of squares or rectangles or into otherwise shaped regions before the production process for generating the work piece is started. As described above, the shape and/or the position of a work piece layer to be produced by selectively irradiating the raw material powder layer may be considered upon subdividing the raw material powder layer into individual regions. A computer-aided simulation may be used for performing the subdivision, in particular in case parameters of the work piece layer should be considered.

It is, however, also conceivable, that the raw material powder layer to be selectively irradiated with electromagnetic or particle radiation is subdivided into a plurality of regions in situ during the production of the three-dimensional work piece. For example, splash particles and/or a smoke plume developing upon irradiating either a previous raw material powder layer or another region of the (same) raw material powder layer are monitored by means of a suitable sensor device, and the shape and the size of the region is then defined based on an output of the sensor device. For example, the edges of the region to be defined may be set as soon as a threshold value for the contamination of the region with particulate impurities is reached. A threshold contamination value may, however, also be considered upon defining the region prior to starting the production of the three-dimensional work piece.

The sensor device may, for example, comprise a camera which directly monitors the development of splash particles and/or a smoke plume generated during irradiation of the raw material powder layer. A camera may, however, also be used to directly detect solidified splash particles deposited on the surface of the raw material powder layer before the next raw material powder layer is applied. Thus, upon determining whether a raw material powder layer region is substantially unaffected or affected by particulate impurities, monitoring results captured by a camera upon monitoring a previous raw material powder layer may be taken into consideration. Upon being monitored by means of a camera, the raw material powder layer may be viewed and/or illuminated from different angles and/or may be illuminated with light of different wavelengths. Alternatively or additionally thereto, a melt pool monitoring system may be employed in order to detect the emission of near-infrared radiation from the melt pool and/or to monitor a vapor capillary, for example for detecting capillary fluctuations. From the detected emission may be determined an amount and direction of splash particles and/or a smoke plume. It may also be possible to determine from the signal a scattering of radiation on particulate impurities generated by the interaction of another radiation beam on the powder.

The size and/or the shape of the regions defined upon subdividing the raw material powder layer may vary between individual raw material powder layers and/or within the (same) raw material powder layer. Further, a raw material powder layer may be subdivided into a plurality of regions prior to starting the production of the three-dimensional work piece and the size and/or the shape of the regions may be adapted in situ as needed.

The determination of whether a region of the raw material powder layer is affected or substantially unaffected by particulate impurities may be made prior to starting the production of the three-dimensional work piece. For example, a region of the raw material powder layer may be defined as being affected or substantially unaffected by particulate impurities based on the location of the region in the raw material powder layer. A computer-aided simulation may be used for said definition.

Alternatively or additionally thereto, the determination of whether a region of the raw material powder layer is affected or substantially unaffected by particulate impurities may be made in situ during the production of the three-dimensional work piece. For example, the development of splash particles and/or a smoke plume developing upon irradiating either a previous raw material powder layer or another region of the (same) raw material powder layer may be monitored by means of a suitable sensor device and the determination of whether a region of the raw material powder layer is affected or substantially unaffected by particulate impurities may then be made based on an output of the sensor device.

Upon the production of a three-dimensional work piece from a plurality of raw material powder layers, the determination of whether a region of a raw material powder layer is affected or substantially unaffected by particulate impurities may be made in such a manner that unaffected and/or affected regions coincide in some or all of the layers. Preferably, however, the determination of whether a region of the raw material powder layer is affected or substantially unaffected by particulate impurities is made so as to vary layer by layer.

In a particularly preferred embodiment of the method of operating an irradiation system, the determination of whether a region of the raw material powder layer is affected or substantially unaffected by particulate impurities is made in dependence on a geometry of a work piece layer which is generated by irradiating the raw material powder layer with electromagnetic or particle radiation. In case the geometry of the work piece layer to be generated is considered upon determining whether a raw material powder layer region is unaffected or affected by particulate impurities, portions of the raw material powder layer which do not coincide with the work piece layer and are thus not irradiated can be disregarded. On the other hand, raw material powder layer portions that coincide with the work piece layer can more accurately be examined in order to determine whether they are unaffected or affected by particulate impurities, since the effects of the work piece geometry on the tendency that particulate impurities are generated in certain portions of the raw material powder layer can be considered.

Alternatively or additionally thereto, the determination of whether a region of the raw material powder layer is affected or substantially unaffected by particulate impurities may be made in dependence on a geometry of a work piece layer which is generated by irradiating a previous raw material powder layer with electromagnetic or particle radiation. By considering the geometry of a previously generated work piece layer upon determining whether a raw material powder layer region is unaffected or affected by particulate impurities, portions of the actual raw material powder layer that may be affected by embedded solidified splash particles which were deposited upon irradiating the previous raw material powder layer can be identified and associated with a raw material powder layer region which is affected by particulate impurities.

The determination of whether a region of the raw material powder layer is affected or substantially unaffected by particulate impurities may be made in dependence on at least one of a range of values of the energy density which is intended to be applied to the raw material powder layer by the irradiation system, a type of gas forming the gas stream directed across the raw material powder layer, the flow rate of the gas stream directed across the raw material powder layer, a pressure prevailing in the surroundings of the raw material powder layer, a thickness of the raw material powder layer, a material contained in the raw material powder layer, an angle at which a radiation bean impinges onto the raw material powder layer, a direction of movement of the radiation beam across the raw material powder layer, in particular relative to the direction of flow of the gas stream, and a distance from a gas flow inlet and/or an upstream edge of the raw material powder layer.

The tendency that particulate impurities are formed upon irradiating the raw material powder layer applied to the raw material powder layer by the irradiation system increases with increasing energy densities applied to the raw material powder layer and with decreasing pressure in the process chamber and hence in the surroundings of the raw material powder layer. Also the type of the gas which is supplied to the process chamber in order to establish a controlled atmosphere within the process chamber and in order to remove particulate impurities from the process chamber influences the tendency of the formation of splash particles when the raw material powder layer is selectively irradiated. For example, a helium gas atmosphere within the process chamber reduces the tendency of the formation of splash particles as compared to a nitrogen gas atmosphere. The thickness of the raw material powder layer directly determines the length of the vapor capillary which is formed upon irradiating the raw material powder layer and hence the tendencies that splash particles are emitted from the melt pool. In addition, the thicker the raw material powder layer is, the higher is the energy density which has to be applied upon irradiating the raw material powder layer. Consequently, it is advantageous to consider at least one of these process parameters upon determining whether the raw material powder layer is unaffected or affected by particulate impurities.

The flow rate of the gas stream directed across the raw material powder layer determines how far splash particles are transported across the raw material powder layer by being entrained with the gas stream. The material of the raw material powder layer influences the tendency of the formation of splash particles and the size of the splash particles. The angle at which the radiation been impinges onto the raw material powder layer influences the tendency of the formation of splash particles and the direction in which the splash particles are emitted. The direction of movement of the radiation beam and in particular the direction of movement of the radiation beam relative to the direction of flow of the gas stream directed across the raw material powder layer influences the direction at which the splash particles are emitted and in which direction the splash particles are transported across the raw material powder layer by being entrained with the gas stream. Thus, a consideration of these parameters also allows a more accurate determination of whether a certain raw material powder layer region is unaffected or affected by particulate impurities.

In case the raw material powder layer is simultaneously irradiated by a plurality of radiation beams, a region of the raw material powder layer which is irradiated by a radiation beam in the surroundings of an irradiation position of another radiation beam may be affected by particulate impurities generated due to the interaction of the other radiation beam with the raw material powder layer. In fact, said region of the raw material powder layer may be affected by both splash particles and the smoke plume which is generated when the other radiation beam irradiates the raw material powder layer. For example, a region of the raw material powder layer which, with respect to a direction of flow of the gas stream directed across the raw material powder layer, is arranged downstream of an irradiation position of the other radiation beam may be affected by particulate impurities which interfere with the irradiation of said region by the radiation beam.

Therefore, the determination of whether a region of the raw material powder layer is affected or substantially unaffected by particulate impurities may be made in dependence on an irradiation position of a plurality of radiation beams relative to each other. In particular, an energy density applied to a region of the raw material powder layer by a radiation beam may be increased in case it is determined that said region of the raw material powder layer is affected by particulate impurities generated due to the interaction of another radiation beam with the raw material powder layer.

It is conceivable that the increased energy density applied to the raw material powder layer in a region which is affected by particulate impurities is maintained constant in the entire affected region. However, the interference of the region by particulate impurities may vary across the region in dependence on the location within the raw material powder layer, the work piece geometry and the above described process parameters. Consequently, different portions of the region may be affected by particulate impurities in a different degree. Therefore, upon selectively irradiating a region of the raw material powder layer which is determined to be affected by particulate impurities, the energy density applied to the region of the raw material powder layer by a radiation beam preferably is varied in dependence on the degree of interference of the region by particulate impurities.

For example, upon irradiating a region of the raw material powder layer by a radiation beam, a smoke plume of lightweight particulate impurities which is generated due to the interaction of another radiation beam (or even of the obstructed radiation beam itself) with the raw material powder layer may shield and/or scatter the radiation beam irradiating the raw material powder layer in the vicinity of the other radiation beam. Therefore, upon selectively irradiating a region of the raw material powder layer by a radiation beam, which region is determined to be affected by particulate impurities generated by another radiation beam, the energy density applied to the region by the radiation beam is increased as compared to the energy density applied to the raw material powder layer by the other radiation beam.

The degree at which the radiation beam is affected by the smoke plume generated by the other radiation beam varies in dependence on the position at which the radiation beam impinges onto the substantially conical smoke plume. This is in particular the case when normal gas flow parameters, given by an amount and speed of gas, most effective in trapping particulate impurities concurrently not disturbing the top powder layer are applied. For example, in case the radiation beam impinges onto the smoke plume in a central region of the smoke plume, the shielding and/or scattering effects affecting the radiation beam will be more severe than in case the radiation beam impinges onto the smoke plume in a tip region of the smoke plume in the vicinity of the irradiation position of the other radiation beam or in an edge region of the smoke plume distant from the irradiation position of the other radiation beam. Therefore, the energy density applied to a region of the raw material powder layer by a radiation beam, which region is affected by a smoke plume generated by another radiation beam may be varied in dependence on an irradiation position of the radiation beam relative to the smoke plume generated by the other radiation beam.

The central region of the smoke plume typically extends from a plane extending through the smoke plume and being located at a distance of approximately 60 mm from the irradiation position of the first radiation beam to a plane extending through the smoke plume and being located at a distance of approximately 400 mm from the irradiation position of the first radiation beam. However, the shape of the smoke plume and the position of the central region may vary in particular in dependence on the position and the direction of movement of the other radiation beam relative to the direction of flow and the flow rate of the gas stream directed across the raw material powder layer. It is clear that the plume generation in general may further be dependent from known influencing factors, e.g. the material of the raw material powder, the angle of incidence of the radiation beam, the used shielding gas, etc.

Upon selectively irradiating a region of the raw material powder layer which is determined to be affected by particulate impurities, the energy density applied to the region of the raw material powder layer by a radiation beam may be increased in discrete increments with an increasing degree of interference of the region by particulate impurities. It is, however, also conceivable to increase the energy density applied to the region of the raw material powder layer by the radiation beam in a continuous manner with an increasing degree of interference of the region by particulate impurities. Finally, it is conceivable that in some portions of the region the energy density is increased in discrete increments with an increasing degree of interference of the region by particulate impurities, whereas in other portions of the region the energy density is increased continuously with an increasing degree of interference of the region by particulate impurities. For example, an increase of the energy density applied to the region of the raw material powder layer which is determined to be affected by particulate impurities may vary from +1% to +100% and in particular from +5% to +50%.

An irradiation system for irradiating layers of a raw material powder with electromagnetic or particle radiation in order to produce a three-dimensional work piece comprises a control device which is configured to subdivide a raw material powder layer to be selectively irradiated with electromagnetic or particle radiation in accordance with a geometry of a corresponding layer of the work piece to be produced into a plurality of regions. The control device further is configured to receive, for at least one region prior to selectively irradiating said region with electromagnetic or particle radiation, a determination input indicating whether said region is affected or substantially unaffected by particulate impurities. The determination of whether a region of a raw material powder layer to be selectively irradiated is affected or substantially unaffected by particulate impurities may be made by means of an appropriate determination device and/or can also be accomplished by a user input into the control device.

The control device further is configured to control an energy density applied to the region of the raw material powder layer by a radiation beam upon selectively irradiating the region of the raw material powder layer with electromagnetic or particle radiation in such a manner that the energy density is higher in case it is determined that the region of the raw material powder layer is affected by particulate impurities than in case it is determined that the region of the raw material powder layer is substantially unaffected by particulate impurities.

The control device may be configured to control the energy density applied to the region of the raw material powder layer by suitably adapting at least one of a power, a focus diameter and a focus shape of a radiation beam directed across the region of the raw material powder layer. Alternatively or additionally, the control device may be configured to control the energy density applied to the region of the raw material powder layer by suitably adapting at least one of a scan speed and a scan pattern according to which the radiation beam is directed across the region of the raw material powder layer.

The determination device may be configured to determine whether a region of the raw material powder layer is affected or substantially unaffected by particulate impurities in dependence on a direction of flow of a gas stream directed across the raw material powder layer and/or in dependence on a spatter trajectory determined based on a flow speed of a gas stream directed across the raw material powder layer, a gas flow profile of a gas stream directed across the raw material powder layer and/or a particle weight of the particulate impurities.

A region of the raw material powder layer which extends for a predetermined distance from an upstream edge of the raw material powder layer in the direction of flow of the gas stream directed across the raw material powder layer and/or which extends for a predetermined distance from an upstream irradiation starting position in the direction of flow of the gas stream directed across the raw material powder layer may be considered as a region of the raw material powder layer which is substantially unaffected by particulate impurities.

The control device may be configured to subdivide the raw material powder layer to be selectively irradiated with electromagnetic or particle radiation into a plurality of regions prior to starting the production of the three-dimensional work piece and/or in situ during the production of the three-dimensional work piece.

The determination device may be configured to determine whether a region of the raw material powder layer is affected or substantially unaffected by particulate impurities prior to starting the production of the three-dimensional work piece (e.g. in the form of a simulation) and/or in situ during the production of the three-dimensional work piece.

The determination device may be configured to determine whether a region of the raw material powder layer is affected or substantially unaffected by particulate impurities in dependence on a geometry of a work piece layer generated by irradiating the raw material powder layer with electromagnetic or particle radiation and/or in dependence on a geometry of a work piece layer generated by irradiating a previous raw material powder layer with electromagnetic or particle radiation.

The determination device may be configured to determine whether a region of the raw material powder layer is affected by particulate impurities or substantially unaffected by particulate impurities in dependence on at least one of a range of values of the energy density which is intended to be applied to the raw material powder layer by the irradiation system, a pressure prevailing in the surroundings of the raw material powder layer, a type of the gas forming the gas stream directed across the raw material powder layer, a thickness of the raw material powder layer, a flow rate of the gas stream directed across the raw material powder layer, a material contained in the raw material powder layer, an angle at which a radiation beam impinges onto the raw material powder layer, a direction of movement of the radiation beam across the raw material powder layer, in particular relative to the direction of flow of the gas stream directed, and a distance from a gas flow inlet and/or an upstream edge of the raw material powder layer.

The determination device may be configured to determine whether a region of the raw material powder layer is affected or substantially unaffected by particulate impurities in dependence on an irradiation position of a plurality of radiation beams relative to each other.

Upon selectively irradiating a region of the raw material powder layer which is determined to be affected by particulate impurities, the control device may be configured to vary the energy density applied to the region of the raw material powder layer by a radiation beam in dependence on the degree of interference of the region by particulate impurities.

Upon selectively irradiating a region of the raw material powder layer by a radiation beam, which region is determined to be affected by particulate impurities generated by another radiation beam, the control device may be configured to increase the energy density applied to the region by the radiation beam as compared to the energy density applied to the raw material powder layer by the other radiation beam.

Upon selectively irradiating a region of the raw material powder layer which is determined to be affected by particulate impurities, the control device may be configured to increase the energy density applied to the region of the raw material powder layer by a radiation beam in discrete increments and/or continuously with an increasing degree of interference of the region by particulate impurities.

An apparatus for producing a three-dimensional work piece is equipped with an above-described irradiation system.

Preferred embodiments of the invention will be described in greater detail with reference to the appended schematic drawings, wherein

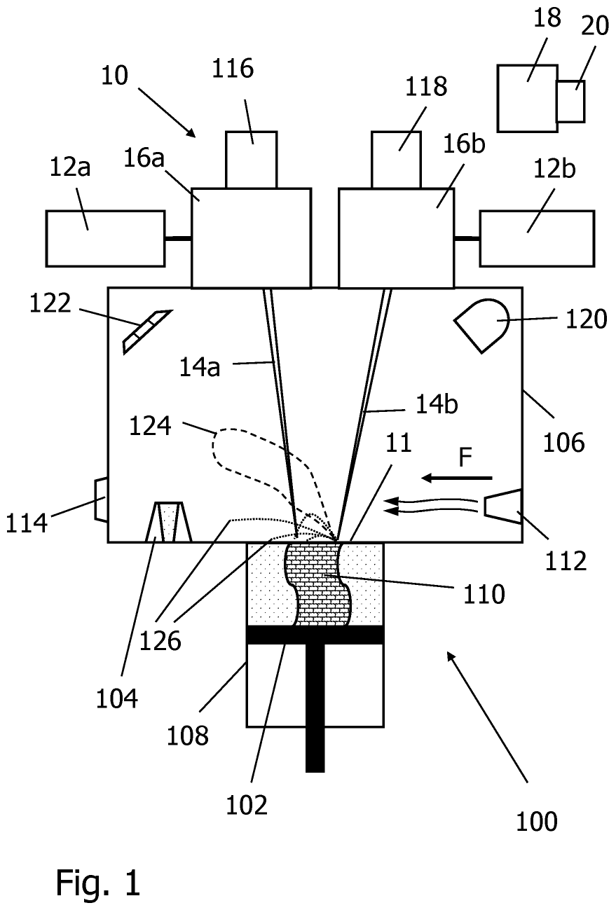

FIG. 1 shows an apparatus for producing a three-dimensional work piece by irradiating layers of a raw material powder with electromagnetic or particle radiation;

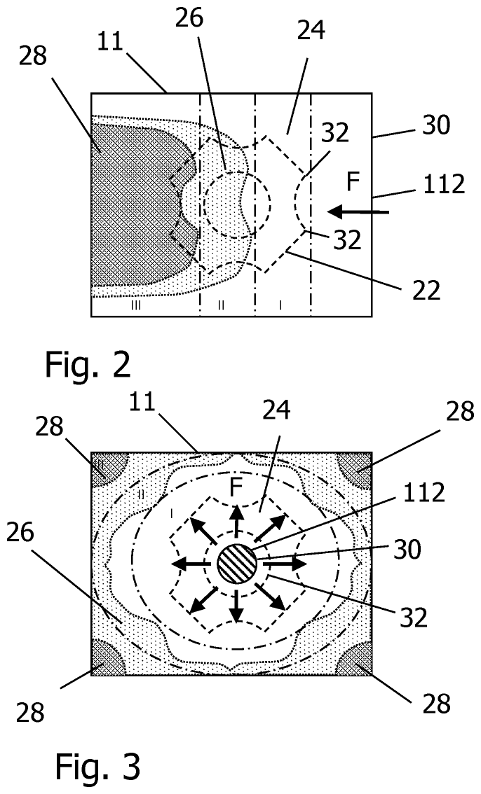

FIG. 2 shows the influence of particulate impurities on different regions of a raw material powder layer which is overflown with a gas stream directed across of the raw material powder layer from a gas inlet arranged in the region of a side edge of the raw material powder layer;

FIG. 3 shows the influence of particulate impurities on different regions of a raw material powder layer which is overflown with a gas stream directed across of the raw material powder layer from a gas inlet arranged in central region of the raw material powder layer; and

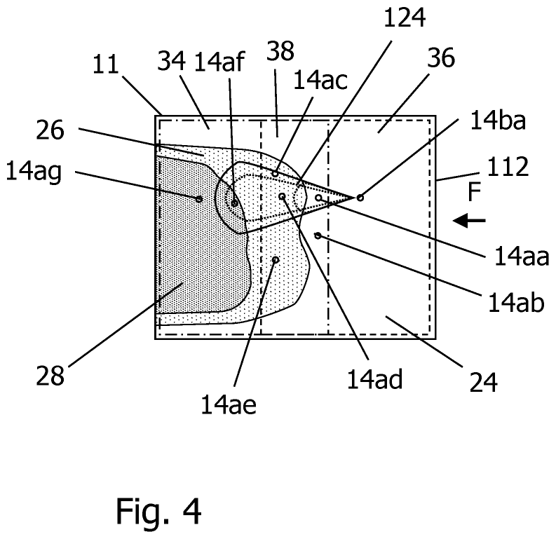

FIG. 4 shows a raw material powder layer while being irradiated by a plurality of radiation beams, wherein a radiation beam is affected by particulate impurities generated by another radiation beam at a different degree in dependence on an irradiation position of the radiation beam relative to an irradiation position of the other radiation beam.

FIG. 1 shows an apparatus 100 for producing a three-dimensional work piece by an additive layering process. The apparatus 100 comprises a carrier 102 and a powder application device 104 for applying a raw material powder onto the carrier 102. The carrier 102 and the powder application device 104 are accommodated within a process chamber 106 which is preferably sealable against the ambient atmosphere. The carrier 102 is displaceable in a vertical direction into a built cylinder 108 so that the carrier 102 can be moved downwards with increasing construction height of a work piece 110, as it is built up in layers from the raw material powder on the carrier 12. The carrier 102 may comprise a heater and/or a cooler.

The apparatus 100 further comprises an irradiation system 10 for selectively irradiating electromagnetic or particle radiation onto the raw material powder layer 11 applied onto the carrier 102. In the embodiment of an apparatus 100 shown in FIG. 1, the irradiation system 10 comprises two radiation beam sources 12a, 12b, each of which is configured to emit a laser beam 14a, 14b. An optical unit 16a, 16b for guiding and processing the radiation beams 14a, 14b emitted by the radiation beam sources 12a, 12b is associated with each of the radiation beam sources 12a, 12b. It is, however, also conceivable that the irradiation system 10 is equipped with more than two or only one radiation beam source and only one optical unit and consequently emits only a single radiation beam. A control device 18 is provided for controlling the operation of the irradiation system 10 and further components of the apparatus 100 such as, for example, the powder application device 104.

A controlled gas atmosphere, preferably an inert gas atmosphere is established within the process chamber 106 by supplying a shielding gas to the process chamber 106 via a process gas inlet 112. After being directed through the process chamber 106 and across the raw material powder layer 11 applied onto the carrier 102, the gas is discharged from the process chamber 106 via a process gas outlet 114. The process gas may be recirculated from the process gas outlet 114 to the process gas inlet 112 and thereupon may be cooled or heated. The shown arrangement of the gas inlet 112 in a sidewall of the process chamber 106 is only exemplary and not limiting. Its clear, that any arrangement could be realized, that could employ a gas stream in the process chamber 106, especially over the raw material powder layer 11, e.g. from the floor or the ceiling of the process chamber 106. There may also be several gas inlets 112.

During operation of the apparatus 100 for producing a three-dimensional work piece, a layer 11 of raw material powder is applied onto the carrier 102 by means of the powder application device 104. In order to apply the raw material powder layer 11, the powder application device 104 is moved across the carrier 102 under the control of the control unit 18. Then, again under the control of the control unit 18, the layer 11 of raw material powder is selectively irradiated with electromagnetic or particle radiation in accordance with a geometry of a corresponding layer of the work piece 110 to be produced by means of the irradiation device 10. The steps of applying a layer 11 of raw material powder onto the carrier 102 and selectively irradiating the layer 11 of raw material powder with electromagnetic or particle radiation in accordance with a geometry of a corresponding layer of the work piece 110 to be produced are repeated until the work piece 110 has reached the desired shape and size.

The radiation energy introduced into the raw material powder by the radiation beams 14a, 14b impinging onto the raw material powder layer 11 causes the raw material powder to melt and/or sinter. Specifically, a melt pool of molten raw material is generated in a region where the radiation beam 14a, 14b impinge on the raw material powder. In the course of the melting of the raw material powder, welding smoke is generated which forms a smoke plume 124 containing lightweight particulate impurities, such as smoke particles, dispersed raw material powder particles and soot particles. Although the major part of the light welding smoke particles is discharged from the process chamber 106 by being entrained with the gas stream guided through the process chamber 106, the smoke plume 124 of lightweight particulate impurities which is generated due to the interaction of the radiation beam 14b may still undesirably shield and/or scatter the radiation beam 14a which, before impinging onto the raw material powder to be irradiated, is directed through the smoke plume 124 caused by the radiation beam 14b.

In addition, the evaporation of raw material from the melt pool causes splash particles 126 to spray from the melt pool. Splash particles 126 that spray from the melt pool in molten form and thereafter solidify typically are too heavy to the entrained with the gas stream guided through the process chamber 106 and hence are deposited either on the surface of non-irradiated raw material powder of a just selectively irradiated raw material powder layer 11 or on the surface of a just generated work piece layer. If the splash particles 126 are deposited in a portion of the raw material powder layer 11 that is still to be irradiated by either of the radiation beams 14a or 14b, these particulate impurities may already affect the quality of the work piece layer portion generated by selectively irradiating said portion of the raw material powder layer 11.

The quality of the work piece layer generated by selectively irradiating said raw material powder layer 11 may, however, also be affected by particulate impurities which are generated upon irradiating a previous raw material powder layer and which are covered with and/or incorporated into the raw material powder of the raw material powder layer 11. Solidified splash particles that reside on the surface of the raw material powder layer 11 and/or that are embedded in the raw material powder layer 11 upon irradiating the raw material powder layer 11 may cause defects and/or irregularities in the work piece 110 to be produced.

The apparatus 100 is equipped with several sensor devices 116, 118, 120. Sensor devices 116, 118 are adapted for monitoring various process parameters, such as the temperature of the gas atmosphere inside the process chamber 106, the temperature of the carrier 106 and the radiation emitted from the melt pool in the focus point of the radiation beams 14a, 14b and/or in an area around the focus point. Sensor devices 116, 118 may, for example, constitute a component of a melt pool monitoring system and may comprise a pyrometer or a suitable camera which is adapted to detect infrared radiation resolved to several locations on a layer of raw material powder and/or to monitor a vapor capillary, for example for detecting capillary fluctuations. The sensed radiation is guided through the optical units 16a, 16b to the sensor devices 116, 118.

The sensor device 120 is adapted to detect the temperature of a raw material powder/work piece layer during and after being irradiated with electromagnetic or particle radiation. The sensor device 120 may, for example, constitute a component of a melt pool monitoring system or a layer control system and may comprise a suitable camera which is adapted to monitor an evenness of an applied powder layer. The sensor device 120 may also be adapted to directly monitor the development of splash particles 126 and/or the smoke plume 124 generated during irradiation of the raw material powder layer 11. The sensor device 120 may, however, also be used to directly detect solidified splash particles deposited on the surface of the raw material powder layer 11 before the next raw material powder layer is applied. Upon being monitored by means of the sensor device 120, the raw material powder layer 11 may be viewed and/or illuminated from different angles and/or may be illuminated with light of different wavelengths by means of an illumination device 122.

In another exemplary embodiment at least one of the sensor devices 116, 118, 120 may be a pyrometer device that may detect a temperature at a specific point inside the process chamber 106, e.g. on the raw material powder layer, or an average temperature over an area inside the process chamber 106, e.g. on the raw material powder layer. The apparatus 100 may comprise further sensor devices, for example for measuring the temperature of the process gas at the process gas inlet 112 or at another location, or for measuring the composition of the process gas inside the process chamber 106. It is understood, that this example is not limiting and an apparatus 100 according to the invention may comprise only few of the named sensors or all of them and may comprise further sensors.

Upon operating the irradiation system 10, a raw material powder layer 11 to be selectively irradiated with electromagnetic or particle radiation in accordance with a geometry of a corresponding layer of the work piece to be produced is subdivided into a plurality of regions prior to starting the production of the three-dimensional work piece or in situ during the production of the three-dimensional work piece.

Further, it is determined for each of the regions prior to selectively irradiating said regions with electromagnetic or particle radiation, whether said regions are affected or substantially unaffected by particulate impurities. The determination of whether a region of the raw material powder layer 11 is affected or substantially unaffected by particulate impurities is made by a determination device 20. The determination device 20 may be associated with the control device 18 or may be formed integral with the control device 18.

The determination of whether a region of the raw material powder layer 11 is affected or substantially unaffected by particulate impurities by means of the determination device 20 may be made prior to starting the production of the three-dimensional work piece 110, for example, based on a preferably computer-aided simulation. Alternatively or additionally thereto, the determination device 20 may perform the determination of whether a region of the raw material powder layer 11 is affected or substantially unaffected by particulate impurities in situ during the production of the three-dimensional work piece 110 based on an output of at least one of the sensor devices 116, 118, 120.

For example, for determining whether a particular region of the raw material powder layer 11 is affected or substantially unaffected by particulate impurities, the development of splash particles 126 and/or the smoke plume 124 upon irradiating a previous raw material powder layer or a different region of the (same) raw material powder layer 11 may be monitored by means of the sensor device 120 with the aid of the illumination device 122 and the determination of whether the region of the raw material powder layer 11 is affected or substantially unaffected by particulate impurities may then be made based on an output of the sensor device 120.

A raw material powder layer region which, with respect to the direction of flow F of the gas stream directed across the raw material powder layer 11, is arranged in a downstream area of the raw material powder layer 11, i.e. distant from the gas inlet 112 of the process chamber 106 and in the vicinity of the gas outlet 114 of the process chamber 106, typically is affected by both splash particles and a smoke plume of lightweight particulate impurities which are emitted from the melt pool when a radiation beam 14a, 14b irradiates a raw material powder layer region which, with respect to the direction of flow of the gas stream F directed across the raw material powder layer 11, is arranged in an upstream area of the raw material powder layer 11, i.e. in the vicinity of the gas inlet 112 of the process chamber 106 and distant from the gas outlet 114 of the process chamber 106.

FIG. 2 shows a top view of a raw material powder layer 11 which is overflown with the gas stream directed through the process chamber 106 and across of the raw material powder layer 11 in a flow direction F from the gas inlet 112 arranged in a sidewall of the process chamber 106 and hence in the region of a side edge of the raw material powder layer 11. The dashed lines in FIG. 2 indicate a cross-section of a work piece layer 22 generated by irradiating the previous raw material powder layer beneath the actual raw material powder layer 11, and may also be understood as indication of a cross-section of a work piece layer 22 to be generated. The raw material powder layer 11 shown in FIG. 3 differs from the raw material powder layer 11 of FIG. 2 only in that the gas inlet 112 for directing gas into the process chamber 106 and across the raw material powder layer 11 is not arranged in the region of the side edge of the raw material powder layer 11, but in a central region of the raw material powder layer 11. The gas outlet (not shown) in FIG. 3 is correspondingly arranged around the raw material powder layer 11.

Each of the raw material powder layers 11 shown in FIGS. 2 and 3 comprises a first region 24 which is substantially unaffected by particulate impurities, a second region 26 which is moderately affected by particulate impurities and a third region 28 which is severely affected by particulate impurities. In the exemplary raw material powder layers 11 according to FIGS. 2 and 3, the particulate impurities affecting the second and the third region 26, 28 of the raw material powder layer 11 were generated upon irradiating a previous raw material powder layer and now are covered with and/or embedded in the raw material powder of the raw material powder layer 11 in the second and the third region 26, 28.

FIGS. 2 and 3, however, clearly indicate that the raw material powder layer regions 26, 28 arranged in a downstream region of the raw material powder layer 11 are more severely affected by particulate impurities than the raw material powder layer region 24 which is arranged in an upstream region of the raw material powder layer 11. Therefore, determining of whether a region of the raw material powder layer 11 is affected or substantially unaffected by particulate impurities the determination device 20 considers a direction of flow F of the gas stream which is directed through the process chamber 106 and across the raw material powder layer 11 in order to establish a desired atmosphere within the process chamber 106 and in order remove particulate impurities from the process chamber 106.

For example, the determination device 20 may consider a region of the raw material powder layer which extends for a predetermined distance from an upstream edge 30 of the raw material powder layer 11 in the direction of flow F of the gas stream directed across the raw material powder layer 11 as a region of the raw material powder layer 11 which is substantially unaffected by particulate impurities. Alternatively or additionally thereto, the determination device 20 may consider a region of the raw material powder layer 11 which extends for a predetermined distance from an upstream irradiation starting position 32 in the direction of flow F of the gas stream directed across the raw material powder layer 11 as a region of the raw material powder layer which is substantially unaffected by particulate impurities. The predetermined distance may be determined by means of the determination device 20 based on an estimation of the “purifying effect” (describing the efficiency of the gas stream in trapping and discharging particulate impurities) of the gas stream directed through the process chamber 106.

Upon the production of a three-dimensional work piece 110 from a plurality of raw material powder layers, the determination device 20 may determine whether a region of a raw material powder layer is affected or substantially unaffected by particulate impurities in such a manner that unaffected and/or affected regions coincide in some or all of the layers. Preferably, however, the determination of whether a region of the raw material powder layer is affected or substantially unaffected by particulate impurities is made so as to vary layer by layer.

In particular, the determination device 122 may perform the determination of whether a region of the raw material powder layer 11 is affected or substantially unaffected by particulate impurities in dependence on a geometry of a work piece layer 22 which is generated by irradiating the raw material powder layer 11 with electromagnetic or particle radiation. Alternatively or additionally thereto, the determination device 122 may determine whether a region of the raw material powder layer 11 is affected or substantially unaffected by particulate impurities in dependence on a geometry of a work piece layer which is generated by irradiating a previous raw material powder layer.

Further, the determination device 20, upon determining of whether a region of the raw material powder layer 11 is affected or substantially unaffected by particulate impurities, may consider at least one of a range of values of the energy density which is intended to be applied to the raw material powder layer 11 by the irradiation system 10, a type of gas forming the gas stream directed across the raw material powder layer 11, the flow rate of the gas stream directed across the raw material powder layer 11, a pressure prevailing in the surroundings of the raw material powder layer 11, a thickness of the raw material powder layer 11, a material contained in the raw material powder layer, an angle at which a radiation beam 14a, 14b impinges onto the raw material powder layer 11, and a direction of movement of the radiation beam 14a, 14b across the raw material powder layer 11, in particular relative to the direction of flow F of the gas stream.

In the exemplary embodiments of a raw material powder layer 11 shown in FIGS. 2 and 3, the determination device 20, upon considering the geometry of the work piece layer 22 generated in the previous powder layer, disregards a region which is arranged directly adjacent to the gas inlet 112. For a region I of the raw material powder layer 11, which is extends for a predetermined distance from the upstream edge 30 of the raw material powder layer 11 in the direction of flow F of the gas stream and which also extends for a predetermined distance from an upstream irradiation starting position 32 in the direction of flow F of the gas stream, the determination device 20 determines that said region I is substantially unaffected by particulate impurities.

A region II which, with respect to the direction of flow F of the gas stream is arranged downstream of the unaffected region I, by means of the determination device 20, is determined to constitute a region of the raw material powder layer 11 which is moderately affected by particulate impurities. Finally, a region III which, with respect to the direction of flow F of the gas stream is arranged downstream of the moderately affected region II, by means of the determination device 20, is determined to constitute a region of the raw material powder layer 11 which is severely affected by particulate impurities. FIGS. 2 and 3 indicate that the regions II and III identified by the determination device 20 do not fully coincide with regions 26, 28, but overlap with the regions 26, 28 to a considerable extent.

FIG. 4 shows a raw material powder layer 11 while being irradiated by a plurality of radiation beams 14a, 14b. The dashed lines in FIG. 4 indicate irradiation sections 34, 36 to be irradiated with the radiation beam 14a and 14b, respectively. An overlap section 38 can be irradiated with both of the radiation beam 14a and 14b. The raw material powder layer 11 of FIG. 4, in a first region 24, is substantially unaffected by particulate impurities generated upon irradiating a previous raw material powder layer. In a second region 26, the raw material powder layer 11, is affected by particulate impurities which were generated upon irradiating the previous raw material powder layer and which are now embedded in the raw material powder layer 11. In a third region 28, the raw material powder layer 11 is affected by particulate impurities, in particular splash particles, generated upon irradiating the previous raw material powder layer and upon irradiating the actual raw material powder layer 11.

In addition, the radiation beam 14b, upon impinging on the raw material powder layer 11, generates a substantially conically shaped smoke plume 124. Said smoke plume 124 may undesirably shield and/or scatter the radiation beam 14a in case the radiation beam 14a, before impinging onto the raw material powder to be irradiated, is directed through the smoke plume 124. The degree at which the radiation beam 14a is affected by the smoke plume 124 generated by the radiation beam 14b varies in dependence on the position at which the radiation beam 14a impinges onto the substantially conical smoke plume 124. In case the radiation beam 14a impinges onto the smoke plume 124 in a central region of the smoke plume 124, the shielding and/or scattering effects affecting the radiation beam 14a are more severe than in case the radiation beam 14a impinges onto the smoke plume 124 in a tip region of the smoke plume 124 in the vicinity of the irradiation position of the radiation beam 14b or in an edge region of the smoke plume 124 distant from the irradiation position of the radiation beam 14b.

Therefore, the determination device 20 performs the determination of whether a region of the raw material powder layer 11 is affected or substantially unaffected by particulate impurities also in dependence on an irradiation position of the plurality of radiation beams 14a, 14b relative to each other. In FIG. 4, different irradiation positions 14aa to 14ag of the radiation beam 14a relative to an irradiation position 14ba of the radiation beam 14b are shown.

Upon selectively irradiating the raw material powder layer 11 with electromagnetic or particle radiation, an energy density applied to a region of the raw material powder layer 11 by a radiation beam 14a, 14b, by means of the control device 18, is controlled in such a manner that the energy density is higher in case it is determined that the region of the raw material powder layer 11 is affected by particulate impurities than in case it is determined that the region of the raw material powder layer 11 is substantially unaffected by particulate impurities. Due to the increased energy density applied to the raw material powder layer region in case it is affected by particulate impurities, not only the raw material powder particles, but also solidified splash particles that are deposited on a surface of the raw material powder layer 11 or embedded in the raw material powder layer 11 melt when the radiation beam 14a, 14b is guided across the region of the raw material powder layer 11. In addition, a shielding and/or scattering effect caused by a smoke plume 124 of lightweight particulate impurities can be compensated for.

The energy density applied to the region of the raw material powder layer 11 may be controlled by suitably adapting at least one of a power, a focus diameter and a focus shape of the radiation beam 14a, 14b directed across the raw material powder layer 11. Alternatively or additionally thereto, the energy density applied to the region of the raw material powder layer 11 may be controlled by suitably adapting at least one of a scan speed and a scan pattern according to which the radiation beam 14a, 14b is directed across the raw material powder layer 11.

Further, upon selectively irradiating a region of the raw material powder layer 11 which is determined to be affected by particulate impurities, the energy density applied to the region of the raw material powder layer 11 by a radiation beam 14a, 14b, under the control of the control device 18, is varied in dependence on the degree of interference of the region by particulate impurities.

In the examples of FIGS. 2 and 3, in region I, which is substantially unaffected by particulate impurities, an increase of the energy density applied to said region I upon being irradiated is not required, and hence set to 0%. In region II, which is moderately affected by particulate impurities, an increase of the energy density applied to said region II is set to +5%. Finally, in region III, which is severely affected by particulate impurities, an increase of the energy density applied to said region III is set to +15%.

In the example of FIG. 4, the influence of particulate impurities generated upon irradiating the previous raw material powder layer, the influence of particulate impurities generated upon irradiating the actual raw material powder layer 11 and the influence of the smoke plume 124 are considered upon setting the energy density applied by the radiation beams 14a, 14b, as shown in the table below.

| | Increase | Increase | | |
|---|---|---|---|---|
| | in energy | in energy | | |
| | density due to | density due to | | |
| | particulate | particulate | Increase in | |
| | impurities | impurities | energy density | Total |
| Irradiation | generated in | generated in | due to smoke | energy |
| position | previous layer | actual layer | plume | density |
| 14ba | 0 | 0 | 0 | 100% |
| 14aa | 0 | 0 | +10% | 110% |
| 14ab | 0 | 0 | 0 | 100% |
| 14ac | +5% | 0 | +5% | 110% |
| 14ad | +5% | 0 | +15% | 120% |
| 14ae | +5% | 0 | 0 | 105% |
| 14af | +10% | +5% | +15% | 130% |
| 14ag | +20% | +15% | 0 | 135% |

As becomes apparent from the table, the energy density applied to a region of the raw material powder layer 11 by the radiation beam 14a, which region is affected by a smoke plume 124 generated by the radiation beam 14b is varied in dependence on an irradiation position of the radiation beam 14a relative to the smoke plume 124 generated by the radiation beam 14b. In addition, upon selectively irradiating a region of the raw material powder layer 11 by the radiation beam 14a, which region is determined to be affected by particulate impurities generated by the radiation beam 14b, the energy density applied to the region by the radiation beam 14a is increased as compared to the energy density applied to the raw material powder layer 11 by the radiation beam 14b.

In the table above, the energy density applied to a region of the raw material powder layer 11 by the radiation beam 14a, 14b increased in discrete increments with an increasing degree of interference of the region by particulate impurities. It is, however, also conceivable to increase the energy density applied to the region of the raw material powder layer 11 by the radiation beam 14a, 14b in a continuous manner with an increasing degree of interference of the region by particulate impurities.

1-16. (canceled)

17. A method of operating an irradiation system for irradiating layers of a raw material powder with electromagnetic or particle radiation in order to produce a three-dimensional work piece, the method comprising the steps:
subdividing a raw material powder layer to be selectively irradiated with electromagnetic or particle radiation in accordance with a geometry of a corresponding layer of the work piece to be produced into a plurality of regions;
determining for at least one region prior to selectively irradiating said region with electromagnetic or particle radiation, whether said region is affected or substantially unaffected by particulate impurities; and
upon selectively irradiating said region of the raw material powder layer with electromagnetic or particle radiation, controlling an energy density applied to the region of the raw material powder layer by a radiation beam in such a manner that the energy density is higher in case it is determined that the region of the raw material powder layer is affected by particulate impurities than in case it is determined that the region of the raw material powder layer is substantially unaffected by particulate impurities.

18. The method according to claim 17,
wherein the energy density applied to the region of the raw material powder layer is controlled by suitably adapting at least one of a power, a focus diameter and a focus shape of a radiation beam directed across the region of the raw material powder layer and/or at least one of a scan speed and a scan pattern according to which the radiation beam is directed across the region of the raw material powder layer.

19. The method of claim 17,
wherein the determination of whether a region of the raw material powder layer is affected or substantially unaffected by particulate impurities is made in dependence on a direction of flow of a gas stream directed across the raw material powder layer and/or in dependence on a spatter trajectory determined based on a flow speed of a gas stream directed across the raw material powder layer, a gas flow profile of a gas stream directed across the raw material powder layer and/or a particle weight of the particulate impurities.

20. The method of claim 19, wherein a region of the raw material powder layer which extends for a predetermined distance from an upstream edge of the raw material powder layer in the direction of flow of the gas stream directed across the raw material powder layer and/or which extends for a predetermined distance from an upstream irradiation starting position in the direction of flow of the gas stream directed across the raw material powder layer is considered as a region of the raw material powder layer which is substantially unaffected by particulate impurities.

21. The method of claim 17,
wherein:
the raw material powder layer to be selectively irradiated with electromagnetic or particle radiation is subdivided into a plurality of regions prior to starting the production of the three-dimensional work piece and/or in situ during the production of the three-dimensional work piece; and/or
the determination of whether a region of the raw material powder layer is affected or substantially unaffected by particulate impurities is made prior to starting the production of the three-dimensional work piece and/or in situ during the production of the three-dimensional work piece.

22. The method of claim 17,
wherein the determination of whether a region of the raw material powder layer is affected or substantially unaffected by particulate impurities is made in dependence on a geometry of a work piece layer generated by irradiating the raw material powder layer with electromagnetic or particle radiation and/or in dependence on a geometry of a work piece layer generated by irradiating a previous raw material powder layer with electromagnetic or particle radiation.

23. The method of claim 17,
wherein the determination of whether a region of the raw material powder layer is affected by particulate impurities or substantially unaffected by particulate impurities is made in dependence on at least one of a range of values of the energy density which is intended to be applied to the raw material powder layer by the irradiation system, a pressure prevailing in the surroundings of the raw material powder layer, a type of the gas forming the gas stream directed across the raw material powder layer, a thickness of the raw material powder layer, a flow rate of the gas stream directed across the raw material powder layer, a material contained in the raw material powder layer, an angle at which a radiation beam impinges onto the raw material powder layer, a direction of movement of the radiation beam across the raw material powder layer, in particular relative to the direction of flow of the gas stream directed, and a distance from a gas flow inlet and/or an upstream edge of the raw material powder layer.

24. The method of claim 17,
wherein the determination of whether a region of the raw material powder layer is affected or substantially unaffected by particulate impurities is made in dependence on an irradiation position of a plurality of radiation beams relative to each other.

25. The method of claim 17,
wherein upon selectively irradiating a region of the raw material powder layer which is determined to be affected by particulate impurities, the energy density applied to the region of the raw material powder layer by a radiation beam is varied in dependence on the degree of interference of the region by particulate impurities.

26. The method of claim 17,
wherein upon selectively irradiating a region of the raw material powder layer by a radiation beam, which region is determined to be affected by particulate impurities generated by another radiation beam, the energy density applied to the region by the radiation beam is increased as compared to the energy density applied to the raw material powder layer by the other radiation beam.

27. The method of claim 17,
wherein upon selectively irradiating a region of the raw material powder layer which is determined to be affected by particulate impurities, the energy density applied to the region of the raw material powder layer by a radiation beam is increased in discrete increments and/or continuously with an increasing degree of interference of the region by particulate impurities.

28. An irradiation system for irradiating layers of a raw material powder with electromagnetic or particle radiation in order to produce a three-dimensional work piece, the irradiation system comprising a control device which is configured to:
subdivide a raw material powder layer to be selectively irradiated with electromagnetic or particle radiation in accordance with a geometry of a corresponding layer of the work piece to be produced into a plurality of regions;
receive, for at least one region prior to selectively irradiating said region with electromagnetic or particle radiation, a determination input indicating whether said region is affected or substantially unaffected by particulate impurities; and
control an energy density applied to the region of the raw material powder layer by a radiation beam upon selectively irradiating the region of the raw material powder layer with electromagnetic or particle radiation in such a manner that the energy density is higher in case it is determined that the region of the raw material powder layer is affected by particulate impurities than in case it is determined that the region of the raw material powder layer is substantially unaffected by particulate impurities.

29. The irradiation system of claim 28,
wherein the control device is configured to control the energy density applied to the region of the raw material powder layer by suitably adapting at least one of a power, a focus diameter and a focus shape of a radiation beam directed across the region of the raw material powder layer and/or at least one of a scan speed and a scan pattern according to which the radiation beam is directed across the region of the raw material powder layer.

30. The irradiation system of claim 28,
wherein a determination device is configured to determine whether a region of the raw material powder layer is affected or substantially unaffected by particulate impurities in dependence on a direction of flow of a gas stream directed across the raw material powder layer and/or in dependence on a spatter trajectory determined based on a flow speed of a gas stream directed across the raw material powder layer, a gas flow profile of a gas stream directed across the raw material powder layer and/or a particle weight of the particulate impurities; and/or
wherein a region of the raw material powder layer which extends for a predetermined distance from an upstream edge of the raw material powder layer in the direction of flow of the gas stream directed across the raw material powder layer and/or which extends for a predetermined distance from an upstream irradiation starting position in the direction of flow of the gas stream directed across the raw material powder layer is considered as a region of the raw material powder layer which is substantially unaffected by particulate impurities; and/or
wherein the control device is configured to subdivide the raw material powder layer to be selectively irradiated with electromagnetic or particle radiation into a plurality of regions prior to starting the production of the three-dimensional work piece and/or in situ during the production of the three-dimensional work piece; and/or
wherein the determination device is configured to determine whether a region of the raw material powder layer is affected or substantially unaffected by particulate impurities prior to starting the production of the three-dimensional work piece and/or in situ during the production of the three-dimensional work piece; and/or
wherein the determination device is configured to determine whether a region of the raw material powder layer is affected or substantially unaffected by particulate impurities in dependence on a geometry of a work piece layer generated by irradiating the raw material powder layer with electromagnetic or particle radiation and/or in dependence on a geometry of a work piece layer generated by irradiating a previous raw material powder layer with electromagnetic or particle radiation; and/or
wherein the determination device is configured to determine whether a region of the raw material powder layer is affected by particulate impurities or substantially unaffected by particulate impurities in dependence on at least one of a range of values of the energy density which is intended to be applied to the raw material powder layer by the irradiation system, a pressure prevailing in the surroundings of the raw material powder layer, a type of the gas forming the gas stream directed across the raw material powder layer, a thickness of the raw material powder layer, a flow rate of the gas stream directed across the raw material powder layer, a material contained in the raw material powder layer, an angle at which a radiation beam impinges onto the raw material powder layer, a direction of movement of the radiation beam across the raw material powder layer, in particular relative to the direction of flow of the gas stream directed, and a distance from a gas flow inlet and/or an upstream edge of the raw material powder layer; and/or
wherein the determination device is configured to determine whether a region of the raw material powder layer is affected or substantially unaffected by particulate impurities in dependence on an irradiation position of a plurality of radiation beams relative to each other.

31. The irradiation system of claim 28,
wherein upon selectively irradiating a region of the raw material powder layer which is determined to be affected by particulate impurities, the control device is configured to vary the energy density applied to the region of the raw material powder layer by a radiation beam in dependence on the degree of interference of the region by particulate impurities; and/or
wherein upon selectively irradiating a region of the raw material powder layer by a radiation beam, which region is determined to be affected by particulate impurities generated by another radiation beam, the control device is configured to increase the energy density applied to the region by the radiation beam as compared to the energy density applied to the raw material powder layer by the other radiation beam; and/or
wherein upon selectively irradiating a region of the raw material powder layer which is determined to be affected by particulate impurities, the control device is configured to increase the energy density applied to the region of the raw material powder layer by a radiation beam in discrete increments and/or continuously with an increasing degree of interference of the region by particulate impurities.

32. An apparatus for producing a three-dimensional work piece which is equipped with an irradiation system of claim 28.
